(19) United States
(12) Patent Application Publication
(10) Pub. No.: US 2003/0116041 A1
(43) Pub. Date: Jun. 26, 2003

(54) Moveable idler carriage for support of a web in relation to an array of inkjet printing devices

(75) Inventors: Kevin Stone Manes, St. Charles, MO (US); John B. Howard, Wildwood, MO (US); David Anthony Kuhn, St. Charles, MO (US)

Correspondence Address: FOLEY AND LARDNER, SUITE 500, 3000 K STREET NW, WASHINGTON, DC, 20007, US

(73) Assignee: DELAWARE CAPITAL FORMATION, INC.

(21) Appl. No.: 10/022,841

(22) Filed: Dec. 20, 2001

(51) Int. Cl. B41F 1/08; B41F 1/10

(52) U.S. Cl. 101/198

(57) ABSTRACT

A printer and a printing method, wherein the printer comprises, in one embodiment: a frame; a set of non-movable print heads fixed to the frame; an idler carriage for carrying a web, said idler carriage disposed a distance from the set of print heads so that ink from the print heads will be received by the web; and a carriage translation assembly to move the idler carriage to vary the distance between the set of print heads and the idler carriage. In a preferred embodiment, the carriage translation assembly comprises at least one slide shaft; wherein the idler carriage is disposed to slide linearly along the slide shaft; and a force mechanism is provided for exerting a force to move the idler carriage linearly along the slide shaft.

### FIELD OF THE INVENTION

The present invention relates generally to the field of printers, and more particularly to the field of printers with an adjustable space between an idler carriage and a print head.

### BACKGROUND OF THE INVENTION

Printing a web with an ink jet array or other comparable array requires a precise distance to be maintained between all elements of the array and a printed surface of the web. Because webs may have differing thicknesses, and because the web is supported from a surface of a web support device opposite from the printing surface, the distance between the ink jet elements and the web support device must be variable. Additionally, it is periodically necessary to create an increased physical separation of the ink jet array from the web for maintenance of the ink jet devices and for service of the web handling components. Previous embodiments have fixed the location of the web handling components and moved the array on ink jet heads as an assembly. Due to the sensitivity of the ink jet printing devices and the multiplicity of interconnecting conduits (ink supply hoses, pressure and vacuum pneumatic hoses, temperature regulating supply and return water hoses, and electrical harnesses), the mechanisms to adjust the position of the ink jet array assembly are unduly elaborate and restrictive.

The present invention is directed to solving the foregoing problems.

### SUMMARY OF THE INVENTION

Briefly, the present invention comprises, in one embodiment, a printer comprising: a frame; a set of non-movable print heads fixed to the frame; an idler carriage for carrying a web, said idler carriage disposed a distance from the set of print heads so that ink from the print heads will be received by the web; and a carriage translation assembly to move the idler carriage to vary the distance between the set of print heads and the idler carriage.

In a further aspect of the present invention, the set of print heads comprise inkjet print heads.

In a further aspect of the present invention, the carriage translation assembly comprises at least one slide shaft; wherein the idler carriage is disposed to slide linearly along the slide shaft; and a force mechanism is provided for exerting a force to move the idler carriage linearly along the slide shaft.

In a further aspect of the present invention, the slide shaft moves within a bearing set in the idler carriage.

In a further aspect of the present invention, an accumulator structure is provided for taking up slack in the web as the idler carriage moves.

In a further aspect of the present invention, the accumulator structure maintains constant web tension throughout the travel range of the idler carriage.

In a further aspect of the present invention, the accumulator structure comprises a leg disposed of an end of the idler carriage and extending away from the print heads in a direction of movement of the idler carriage; and an idler roll disposed at the end of the leg, with the web extending down along the leg, around the idler roll, and back up to the idler carriage.

In a further aspect of the present invention, the accumulator structure comprises at least one accumulator roll; and an accumulator roll tensioner for automatically positioning the accumulator roll in response to the movement of the idler carriage in order to maintain a tension on the web.

In a further aspect of the present invention, the accumulator roll tensioner includes a piston actuator that is controlled by a signal indicative of the movement of the idler carriage.

In a further aspect of the present invention, the accumulator structure includes at least three rolls, with a center roll thereof being movable by a piston actuator.

In a further aspect of the present invention, the force mechanism is an piston actuator.

In a further aspect of the present invention, at least one fixed block is provided and located in the frame to set, at least in part, the upper position of the idler carriage.

In a further aspect of the present invention, a clamping mechanism is provided to provide a mechanical compressing force to the idler carriage at an upper position of the idler carriage to the fixed block.

In a further aspect of the present invention, a position of the at least one clamping mechanism is determined by a piston actuator.

In a further aspect of the present invention, alternate upper positions of the idler carriage may be achieved by extending a shim between the fixed block and the idler carriage.

In a further aspect of the present invention, the shim is used to accommodate varying web thickness by providing multiple or stepped elements which may be selectively placed between the fixed block and the idler carriage to set the proper distance of the web to the printer.

In a further aspect of the present invention, an actuator is provided for moving the shim, which was selected for the appropriate web thickness, into position between the fixed block and the idler carriage extension point.

In a further aspect of the present invention, a plurality of the shims of different thicknesses are set on a bar, and the bar is disposed so that when it is moved by the actuator laterally relative to the block, a selected one of the plurality of shims is disposed between the fixed block and the idler carriage

In a further aspect of the present invention, the clamping hook provides a mechanical compressing force between the fixed block, the shim, and the idler carriage extension point.

In a further aspect of the present invention, the carriage translation assembly includes at least three slides shafts disposed in parallel relative to each other.

In a further aspect of the present invention, the fixed block is disposed at one end of the slide shaft.

In a further embodiment of the present invention, a method for adjusting the idler carriage for a printer is disclosed, comprising the steps of providing a movable idler carriage; and moving the idler carriage to make an adjustment in spacing between a web and a fixed print head.

In a further aspect of the present invention, the moving step comprises sliding the idler carriage along a slide shaft.

In a further aspect of the present invention, the step is provided of maintaining a substantially constant tension on the web as the idler carriage is moved.

In a further aspect of the present invention, the maintaining a substantially constant tension step comprises running the web across an accumulator roll; and automatically positioning the accumulator roll in response to movement of the idler carriage.

In a further aspect of the present invention, the step is provided of moving at least one shim into place between a fixed block and the idler carriage in order to change the upper most position of the idler carriage.

In a yet further aspect of the present invention, the moving the at least one shim step comprises moving a bar with at least two different thickness shims thereon in order to change the shim between the fixed block and the idler carriage to thereby change the upper most position of the idler carriage.

In a yet further embodiment of the present invention, a printer is provided comprising: a frame; a set of non-movable print head means fixed to the frame; an idler carriage means for carrying a web, said idler carriage means disposed a distance from the set of print head means so that ink from the print head means will be received by the web; and a carriage translation means to move the idler carriage means to vary the distance between the set of print head means and the idler carriage means.

In yet a further aspect of the present invention, means are provided for taking up slack in the web as the idler carriage means moves.

In yet a further aspect of the present invention, means are provided for setting alternate upper positions of the idler carriage means.

### BRIEF DESCRIPTION OF THE DRAWINGS

FIG. 1 is a schematic perspective diagram of a preferred embodiment of the present invention.

FIG. 2 is a side view of the preferred embodiment of the present invention.

FIG. 3 is a schematic perspective diagram of an alternate embodiment of the present invention.

FIG. 4 is a schematic block diagram of a preferred embodiment of an aspect of the present invention.

### DETAILED DESCRIPTION OF THE PREFERRED EMBODIMENTS

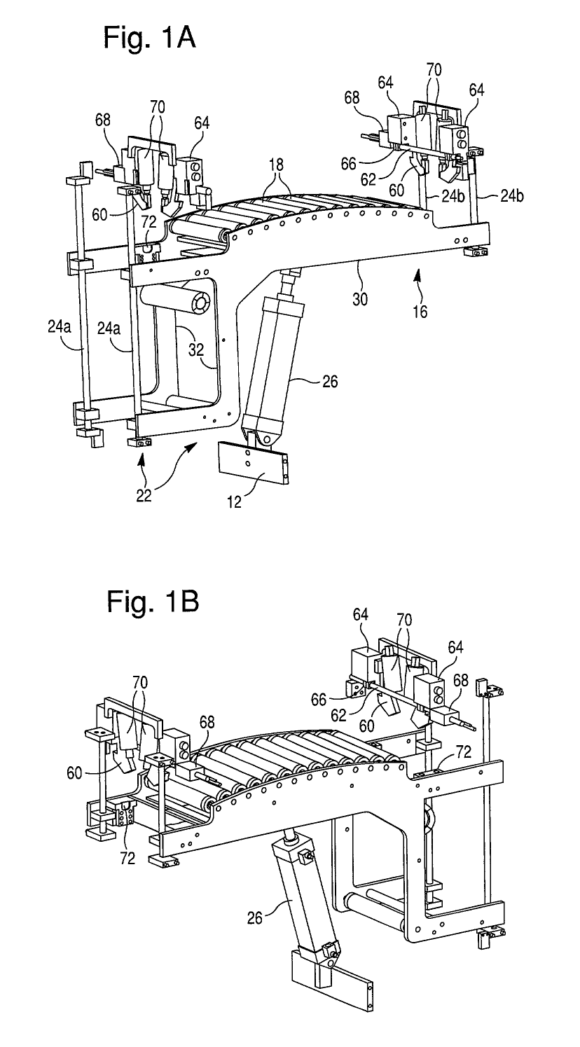

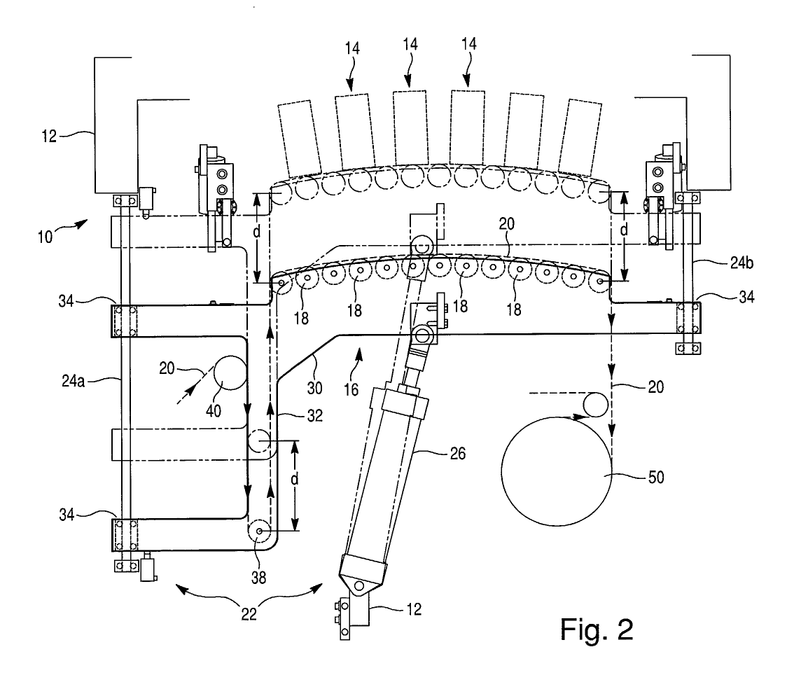

Referring now to FIGS. 1 and 2, there is shown a preferred embodiment of the present invention. It should be noted that FIG. 1b is a mirror image of FIG. 1a, i.e., FIG. 1a is a side perspective view from one side, and FIG. 1b is a side perspective view from the opposite side. A printer 10 is disclosed comprising a frame 12 (shown only in brief outline in FIG. 2), and a set 14 of non-moveable print heads fixed to the frame 12. The invention further includes an idler carriage 16 which includes a bed of idler rolls 18 for carrying a web 20. The web 20 is shown via dashed lines in FIG. 2. The idler carriage 16 is disposed a distance from the set of print heads 14 so that ink from the printers will be received by the web 20. The invention further includes a carriage translation assembly 22. The carriage translation assembly 22 comprises, in a preferred embodiment, a plurality of elements including at least one slide shaft 24 and a force mechanism 26 for exerting a force to move the idler carriage 16 linearly along the slide shaft 24. In the embodiment shown in the figures, the movement of the idler carriage is up and down along the slide shaft 24.

Referring with more particularity to the idler carriage 16, it can be seen that it comprises a frame 30 that includes on one side thereof a lower leg 32. The bed of idler rolls 18 are disposed along the top of the idler carriage 16 as shown in the figure. The idler carriage 16 includes a plurality of bearings 34 to facilitate the sliding movement of the idler carriage linearly along the slide shafts 24. In a preferred embodiment, the bearings 34 comprises linear bearings.

In a preferred embodiment, there are four slide shafts 24. Two slide shafts 24a are disposed and set to slide within the two bearings on the left side of the idler carriage, and two shorter slide shafts 24b are disposed and set to slide within the two bearings 34 on the right side of the idler carriage 16, with each facilitating the sliding movement of the idler carriage 16 in the direction of the slide shaft. In a preferred embodiment, the force mechanism 26 comprises a piston actuator such as an air piston, which is connected at a lower end to the frame 12, and connected at an upper end to the idler carriage 16.

The figures show the position of the idler carriage in its lowest position in solid lines, and illustrate the position of the idler carriage at its uppermost position in phantom lines. It can seen that there will be a difference in web length of 2 d between the lower position of the idler carriage 16 and its upper position. It was discovered that the slack created by the movement of the idler carriage between the upper position and the lower position can be a problem. Accordingly, in a preferred embodiment of the present invention, an accumulator structure is provided for taking up the slack in the web as the idler carriage 16 moves between its upper position and its lower position. In a preferred embodiment of this accumulator structure, the accumulator structure comprises the leg 32 disposed at one end of the idler carriage 16 and extending vertically away from the print head 14 in the direction of movement of the idler carriage 16. An idler roll 38 is disposed at the farthest vertical end of the leg 32 as shown in the figures. The web 20 then takes a path vertically down to the idler roll 38, around the idler roll 38, and then vertically up to the bed of the idler rolls 18 in the idler carriage 16, which are substantially parallel to the set of print head 14. It can be seen that with this 180 wraparound the idler roll 38, and because the leg 32 extends in the direction of movement of the idler carriage 16, that there is a compensating web path of length 2 d which substantially compensates for the extra web path length of 2 d when the idler carriage 16 is moved between its lower position and its farthest upper position. The parallelism of this accumulator web path to the direction of movement of the idler carriage 16 in combination with the 180 wraparound of the path provides this compensation. Accordingly, as the idler carriage 16 is moved, the change in the web path caused by the movement at the top end is compensated by a change in the web path around the leg 32 at the accumulator. Accordingly, it can be seen that the accumulator structure in the preferred embodiment with the lower leg extension 32 forms a complementary web path so that when the idler carriage 16 moves down, the slack in the web is taken up by the additional web path created by the movement of the leg 32 downward. Accordingly, the accumulator structure maintains a substantially constant web tension throughout the travel range of the idler carriage 16.

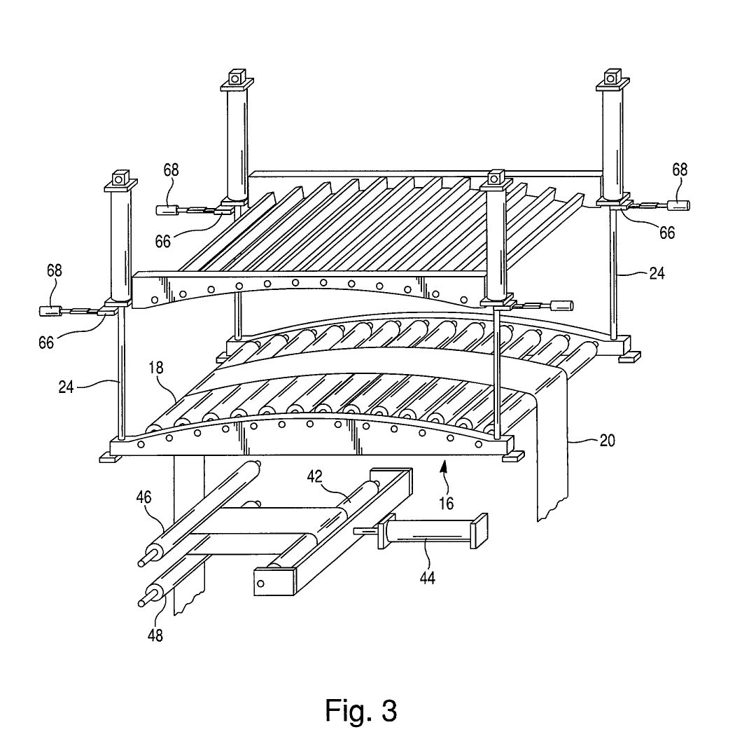

Referring to FIG. 3, an alternative embodiment of the accumulator structure is shown. Note that FIG. 3 is only provided in order to show details of an alternative accumulator mechanism and elements such as the shims 66 are not shown as they would be implemented. In this configuration, the slide shafts 24 may be of substantially the same length. The accumulator structure for taking up the slack in the web as the idler carriage 16 moves comprises at least one accumulator roll 42, and an accumulator roll tensioner 44 for automatically positioning the accumulator roll 42 in response to the movement of the idler carriage 16 in order to maintain a tension on the web 20. In a preferred embodiment of this alternate accumulator structure, there are three accumulator rolls, 42, 46, and 48, with the web 20 taking a path around these accumulator rolls as shown in FIG. 3. In this embodiment, only the accumulator roll 42 is moveable. The accumulator roll tensioner 44 may comprise any convenient means of moving the roll 42. In FIG. 3, the accumulator roll tensioner 44 comprises a piston actuator that is controlled by a signal which is indicative of the movement of the idler carriage 16.

In the embodiment shown in FIGS. 1 and 2, a driven cylinder 50 may be utilized to drive the web 20.

There may be at least one fixed block 64 in the frame 12, which sets, at least in part, an upper position of the idler carriage 16. In a preferred embodiment, a mechanism is provided for giving a mechanical compressing force to clamp the idler carriage 16 at one or more such desired upper positions relative to the fixed block 64. In a preferred embodiment, this structure comprises at least one clamping mechanism 60 such as a hook adjustably connected to the frame 12. In a preferred embodiment, there are four hook 60, with two hook 60 disposed at each end of the idler carriage 16, as shown in FIG. 1. These hooks 60 are adjusted to a bar 62 which is connected to the frame 12.

A variety of different adjustment mechanisms can be utilized in order to adjust the positions of the hook 60. By way of example, but not by way of limitation, the adjustment mechanism for the hooks 60 could comprise one or more shims, which may be of different sizes, and which may be insertable between the idler carriage 16 and the block 64 in order to change the vertical location of the hooks 60 relative to the fixed block 64 attached thereto. To facilitate this operation, in a preferred embodiment the block 64 may have a protrusion (not shown) at the bottom thereof about the width of a shim. One or the other of the shims is moved under the protrusion.

In a preferred embodiment of this adjustment mechanism, a piston actuator 68, such as an air actuator for example, may be utilized to slide the shims or set of shims 66 between the block 64 and the idler carriage 16 to thereby change the upper position of idler carriage 16. In one embodiment of the present invention, the shims could provide 0.005 inches of thickness to thereby change the position of the hooks 60 relative to the block 64.

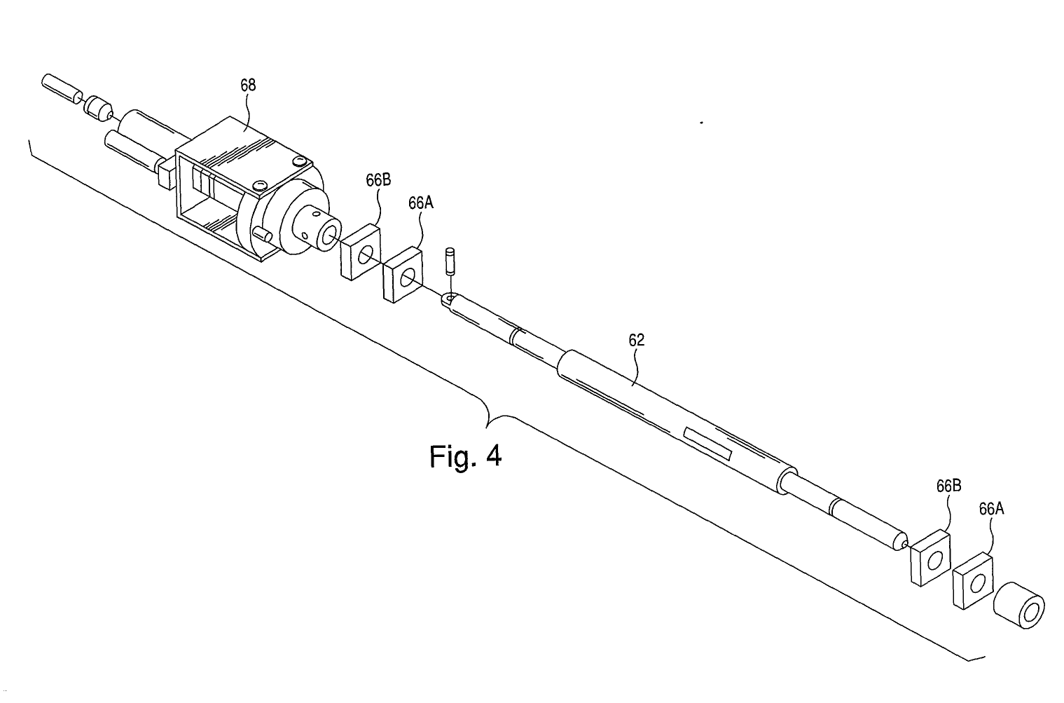

In a preferred embodiment shown in FIG. 4, the shims 66 may be set on a bar 62 that is designed to move laterally under control of the piston actuator 68, to move the bar 68 back and forth under the block 64. The bar 62 may be supported in bearings set in the frame. In a preferred embodiment, the tolerances of the bearings may be set to allow the bar 62 to float by a small amount relative to the fixed block 64 to allow for different thicknesses for the shims 66. This floating aspect facilitates a plurality of shims 66 of different thicknesses being attached to the bar 62. Thus, a different set of shims may be provided for each material thickness. For example, to operate with the back and forth movement of the bar 62, a first set of shims 66A both of a predetermined thickness for a predetermined web may be disposed so that one shim in the first set is under the left-most block 64, and the other shim in the first set is under the right-most block 64. For a thicker web, a second set of shims 66B of a thickness to accommodate this thicker web may be attached to the bar 62, with one shim in this second set attached to the bar 62 to the left of the thinner shim in the first set of shims under the left-most block 64, and the other of the shims in the second set of shims attached to the bar 62 to the left of the thinner shim under the right-most block 64. Accordingly, when the piston actuator 68 moves the bar to the right in the drawing by the width of one shim, the second set of thicker shims are slid under the left and right blocks 64. It can be seen that multiple other sets of shims of different thicknesses may be disposed on the bar 62.

The hooks 60 are designed to interface with and hook into structure at location 72 in the idler carriage 16. A mechanism 70 may be provided to retract the hooks after the hooks 60 have interfaced with the idler carriage at the location 72. After the hooks have been appropriately interfaced at the location 72 in the idler carriage, then the hooks may be retracted by means of the mechanism 70. In a preferred embodiment, the mechanism 70 comprises piston actuators, such as air actuators. The positions of the hooks set by the piston actuators 70 may be binary or may have more than two positions, depending on the engineering design.

The foregoing description of a preferred embodiment of this invention has been presented for purposes of illustration and description. It is not intended to be exact nor to limit the invention to the precise form disclosed, and modification and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended thereto, and their equivalent.

What is claimed is:

1. A printer comprising:
a frame;
a set of non-movable print heads fixed to the frame;
an idler carriage for carrying a web, said idler carriage disposed a distance from the set of print heads so that ink from the print heads will be received by the web; and
a carriage translation assembly to move the idler carriage to vary the distance between the set of print heads and the idler carriage.

2. The printer as defined in claim 1, wherein the set of print heads comprise inkjet print heads.

3. The printer as defined in claim 1, wherein the carriage translation assembly comprises at least one slide shaft;
wherein the idler carriage is disposed to slide linearly along the slide shaft; and
a force mechanism is provided for exerting a force to move the idler carriage linearly along the slide shaft.

4. The printer as defined in claim 3, wherein the slide shaft moves within a bearing set in the idler carriage.

5. The printer as defined in claim 1, further comprising an accumulator structure for taking up slack in the web as the idler carriage moves.

6. The accumulator structure as defined in claim 5, wherein the accumulator structure maintains constant web tension throughout the travel range of the idler carriage.

7. The printer as defined in claim 5, wherein the accumulator structure comprises a leg disposed at an end of the idler carriage and extending away from the print heads in a direction of movement of the idler carriage; and
an idler roll disposed at the end of the leg, with the web extending down along the leg, around the idler roll, and back up to the idler carriage.

8. The printer as defined in claim 5, wherein the accumulator structure comprises at least one accumulator roll; and
an accumulator roll tensioner for automatically positioning the accumulator roll in response to the movement of the idler carriage in order to maintain a tension on the web.

9. The printer as defined in claim 8, wherein the accumulator roll tensioner includes a piston actuator that is controlled by a signal indicative of the movement of the idler carriage.

10. The printer as defined in claim 8, wherein the accumulator structure includes at least three rolls, with a center roll thereof being movable by a piston actuator.

11. The printer as defined in claim 3, wherein the force mechanism is an piston actuator.

12. The printer as defined in claim 1, further comprising at least one fixed block located in the frame which sets, at least in part, the upper position of the idler carriage.

13. The printer as defined in claim 12, further comprising a clamping mechanism to provide a mechanical compressing force to the idler carriage at an upper position of the idler carriage to the fixed block.

14. The printer as defined in claim 13, wherein a position of the at least one clamping mechanism is determined by a piston actuator.

15. The printer as defined in claim 13, wherein alternate upper positions of the idler carriage may be achieved by extending a shim between the fixed block and the idler carriage.

16. The printer as defined in claim 15, wherein a plurality of shims are used to accommodate varying web thickness by providing multiple or stepped elements which may be selectively placed between the fixed block and the idler carriage to set the proper distance of the web to the printer.

17. The printer as defined in claim 15, further comprising an actuator for moving the shim, which was selected for the appropriate web thickness, into position between the fixed block and the idler carriage.

18. The printer as defined in claim 17, wherein a plurality of the shims of different thicknesses are set on a bar, and wherein the bar is disposed so that when it is moved by the actuator laterally relative to the block, a selected one of the plurality of shims is disposed between the fixed block and the idler carriage.

19. The printer as defined in claim 13, wherein the clamping hook provides a mechanical compressing force between the fixed block, the shim, and the idler carriage extension point.

20. The printer as defined in claim 1, wherein the carriage translation assembly includes at least three slides shafts disposed in parallel relative to each other.

21. The printer as defined in claim 12, wherein the fixed block is disposed at one end of the slide shaft.

22. A method for adjusting the idler carriage for a printer, comprising the steps of providing a movable idler carriage; and
moving the idler carriage to make an adjustment in spacing between a web and a fixed print head.

23. The method as defined in claim 22, wherein the moving step comprises sliding the idler carriage along a slide shaft.

24. The method as defined in claim 22, further comprising the step of maintaining a substantially constant tension on the web as the idler carriage is moved.

25. The method as defined in claim 24, wherein the maintaining a substantially constant tension step comprises running the web across an accumulator roll; and
automatically positioning the accumulator roll in response to movement of the idler carriage.

26. The method as defined in claim 22, further comprising moving at least one shim into place between a fixed block and the idler carriage in order to change the upper most position of the idler carriage.

27. The method as defined in claim 26, wherein the moving the at least one shim step comprises moving a bar with at least two different thickness shims thereon in order to change the shim between the fixed block and the idler carriage to thereby change the upper most position of the idler carriage.

28. A printer comprising:
a frame;
a set of non-movable print head means fixed to the frame;
an idler carriage means for carrying a web, said idler carriage means disposed a distance from the set of print head means so that ink from the print head means will be received by the web; and
a carriage translation means to move the idler carriage means to vary the distance between the set of print head means and the idler carriage means.

29. The printer as defined in claim 28, further comprising means for taking up slack in the web as the idler carriage means moves.

30. The printer as defined in claim 28, further comprising means for setting alternate upper positions of the idler carriage means.
